(19) United States
(12) Patent Application Publication
(10) Pub. No.: US 2011/0228400 A1
(43) Pub. Date: Sep. 22, 2011

(54) Method for Manufacturing an Optical Article with Anti-Glare Properties

(75) Inventors: Annette Cretier, Charenton Le Pont (FR); Gerhard Keller, Charenton Le Pont (FR); Philippe Vaneeckhoutte, Charenton Le Pont (FR)

(73) Assignee: ESSILOR INTERNATIONAL (COMPAGNIE GENERALE D'OPTIQU E), Charenton Le Pont (FR)

(21) Appl. No.: 13/131,765

(22) PCT Filed: Nov. 26, 2009
(86) PCT No.: PCT/FR2009/052318

§ 371 Date: May 27, 2011

(30) Foreign Application Priority Data
Nov. 27, 2008 (FR) 0858066

(51) Int. Cl. G02B 1/11

(52) U.S. Cl. 359/586

(57) ABSTRACT

The present invention relates to a method for making an optical article with anti-reflection properties, comprising the steps of:
a) forming on at least one main surface of a support, by applying a sol comprising at least one colloidal mineral oxide with a refractive index higher than or equal to 1.80 having an initial porosity;
b) optionally, forming on the first lower layer by applying a sol comprising at least one colloidal mineral oxide with a refractive index lower than 1.65 a second lower layer having an initial porosity at least equal to the initial porosity of said first layer;
c) applying onto the one or more lower layer(s) an upper layer composition of an optically transparent polymer material with a refractive index lower than or equal to 1.50;
d) filling the porosity of the one or more lower layer(s) through penetration into the one or more lower layer(s) of at least part of the material of the upper layer composition formed in step (c) and forming a cured upper layer which thickness is determined so that the upper layer and the one or more lower layer(s), once the initial porosity thereof has been filled, form a bilayered anti-reflection coating, within the range of from 400 to 700 nm, preferably of from 450 to 650 nm.

The present invention relates to a method for making an optical article, for example an ophthalmic lens, comprising an at least bilayered anti-reflection stack on a transparent substrate made of an organic or mineral glass, optionally coated, as well as to the thus obtained optical article provided with anti-reflection properties.

As a rule, anti-reflection coatings (also referred to as AR in the present application) are typically deposited, not directly onto the transparent substrate, for example a lens, but rather onto abrasion-resistant coatings that have been previously deposited either onto the bare substrate or onto the substrate coated with an adhesion and/or impact-resistant primer.

As is known, the anti-reflection coating layers are most often applied by vacuum deposition, according to one of the following techniques: by evaporation, optionally under ion assistance, by spraying with an ion beam, by cathode sputtering, or by plasma assisted chemical vapor deposition.

It is also known from the state in the art to prepare anti-reflection coatings by a sol-gel process.

These anti-reflection coatings may be deposited by spin coating or by dip coating.

Such anti-reflection coatings are described for example in the U.S. Pat. Nos. 5,104,692, and 4,590,117.

None of the methods described in these patents allowed to provide a widely accepted product in the ophthalmic optics field.

One of the drawbacks of the techniques described in these patents lies in the difficulty to obtain a proper thickness control and cosmetically acceptable anti-reflection coatings, that is to say without visually perceptible optical defects, especially when they are deposited by dip coating.

The optical or mechanical properties of these anti-reflection coatings deposited using a liquid technique, especially by a sol-gel process, are often poorer as compared to those of anti-reflection coatings obtained by means of the traditional technique (by evaporation).

As a result of these various drawbacks, anti-reflection coatings deposited by a sol-gel process are still poorly developed in the ophthalmic optics field.

Thus, the commercially available anti-reflection coatings obtained by means of a sol-gel process in the ophthalmic optics field are not numerous and they are deposited by spin coating, which is a more expensive method.

The patent application WO2006/095469 describes monolayered AR coatings obtained from silica hollow particles. It would be desirable to improve the abrasion- and scratch resistance properties, the resistance to humidity, as well as the resistance to all such combined treatments, and also the optical properties of such AR coatings.

In a related field it has been proposed in the patent application WO 03/056366, in the name of the applicant, to solve the problem of interference fringes that are formed at the interface between a substrate and a polymer layer by inserting between said substrate and the layer of polymeric nature an initially porous quarter-wave plate (λ/4) based on colloidal mineral oxide particles, the porosity of which has been at least partially filled, generally totally or almost totally filled, with the material of the polymer layer or the material of the substrate, when this one is polymeric in nature. Such structure efficiently reduces the interference fringe intensity.

In the preferred embodiment of the invention of the patent application WO 03/056366, the quarter-wave plate is directly contacting the substrate, on one face thereof, and on the other face, is directly contacting an impact-resistant primer coating, that is in turn coated with an abrasion-resistant coating.

In this stack, the mechanical surface properties of the quarter-wave plate do not play a major role since this layer is an intermediate layer which surface is not directly exposed to the external physical events.

The quarter-wave plate described in this application is not an anti-reflection stack.

By definition, an anti-reflection coating means an anti-reflection stack that reduces the reflection at the air/lens interface, provided on the lens external face, that is the furthest from the substrate.

The anti-reflection coating is in contact with the air or separated from the air through a fine additional layer and is intended to resist to the external physical events.

Therefore, the anti-reflection stack may be coated, on the external face thereof, with a fine additional layer typically thinner than 50 nm, preferably thinner than 10 nm, and even more preferably thinner than 5 nm, changing its mechanical surface properties, such as a hydrophobic and/or oleophobic layer well known from the state of the art and which as a result improves the anti-fouling properties.

If so, this fine external layer does form the lens-air interface. Such a layer does not modify or very lightly the optical properties of the AR stack.

Temporary layers may also be deposited onto the surface of the anti-fouling layer for facilitating the implementation of edging operations and are removed after such edging process.

It is a first object of the present invention to provide a method for making an anti-reflection coating, the stack of which is obtained by means of a liquid process, that is to say by successively depositing solutions, especially of the sol-gel type, which would be easily carried out using liquid process depositions, especially by dip coating, especially without necessarily requiring for the solutions to be heated after their deposition and prior to depositing the next solution.

It is a second object of the present invention to provide anti-reflection coatings essentially obtained by means of a liquid process, the optical and/or mechanical properties of which are improved as compared to the anti-reflection coatings known as the state of the art.

It is a further object of the present invention to provide anti-reflection coatings, free of any appearance defect.

According to the invention, the anti-reflection coating is effected by depositing a mono- or multi-layered stack having some degree of porosity, and by applying on the surface of this stack an upper layer made of a curable composition, at least part of which will spread within the one or more porous layer(s) and fill the porosity thereof.

By adjusting the thickness of the residual curable composition layer, after diffusion within the layers of this curable composition, an anti-reflection coating can be formed, for example of the high refractive index/low refractive index (HI/LI) bilayer type, with respective optical depths of λ/2-λ/4 or λ/2-3λ/4.

The respective definitions of the HI and LI layers are given hereunder in relation to the description of the various particular layers, but may be generalized to any anti-reflection coating HI or LI layer.

Therefore, the present invention relates to a method for making an optical article with anti-reflection properties, comprising the steps of:

a) forming on at least one main surface of a support, by applying a sol comprising at least one colloidal mineral oxide with a refractive index higher than or equal to 1.80 and optionally a binder, a first lower layer comprising at least one colloidal mineral oxide with a refractive index higher than or equal to 1.80 and optionally a binder, having an initial porosity;

b) optionally, forming on the first lower layer a second lower layer having an initial porosity at least equal to, preferably higher than the initial porosity of said first layer, by applying a sol comprising at least one colloidal mineral oxide with a refractive index lower than 1.65 and optionally a binder;

c) applying onto the one or more lower layer(s) an upper layer composition of an optically transparent polymer material with a refractive index lower than or equal to 1.50;

d) filling the porosity of the one or more lower layer(s) through penetration into the one or more lower layer(s) of at least part of the material of the upper layer composition formed in step (c) and, optionally, part of the binder, and forming a cured upper layer which thickness is determined so that the upper layer and the one or more lower layer(s), once the initial porosity thereof has been filled, form a bilayered anti-reflection coating, within the range of from 400 to 700 nm, preferably of from 450 to 650 nm.

As used herein, an “anti-reflection coating” or an “anti-reflection stack” is intended to mean a coating which Rᵥ value per face is lower than or equal to 2.5%. The “mean luminous reflection factor,” noted Rᵥ, is such as defined in the standard ISO 13666:1998, and measured in accordance with the standard ISO 8980-4, in other words it is the spectral reflectivity weighted average within the whole range of the visible spectrum of from 380 to 780 nm.

The anti-reflection coatings obtained according to the method of the invention enable reaching Rᵥ values that are lower than 2% per face, and more preferably that are lower than or equal to 1.5% per face, and even more preferably that are lower than or equal to 1% per face.

Preferably, the bilayered anti-reflection coating forms a stack having an optical depth λ/2-λ/4 or λ/2-3λ/4 for a wavelength λ ranging from 500 to 600 nm.

Preferably, said first lower layer has a physical thickness ranging from 100 to 160 nm once its initial porosity has been filled.

In a first embodiment of the invention, the method does not comprise any step b) for forming a second lower layer and the bilayered anti-reflection coating is comprising said first lower layer, once its initial porosity has been filled, and of the upper layer.

Depending on whether the upper layer belongs to an anti-reflection coating of the λ/2-λ/4 or λ/2-3λ/4 type, the upper layer has a physical thickness within preferred ranges of from 70 to 90 nm or from 250 to 290 nm.

In a second embodiment of the invention, step b) of the method is carried out, that is to say a second lower layer is deposited. Thereafter the upper layer composition is deposited and the whole material of the upper layer composition is allowed to penetrate into the lower layers so as to fill them therewith. In this embodiment, the bilayered anti-reflection coating is formed with said first and second layers once their pores have been filled.

In this embodiment of the present invention, “to allow the whole material of the upper layer composition penetrate” is intended to mean that the material of the upper layer, after penetration into and filling of the lower layer porosity, has no more residual thickness or forms a very thin layer of a few nanometers, without leading to significant changes in the optical properties of the thus obtained AR stack.

In addition to the bilayered anti-reflection coatings described hereabove, the person skilled in the art may envisage other thickness ranges such as a bilayered AR coating with a HI lower layer of from 10 to 30 nm and a LI upper layer of from 80 to 120 nm.

The lower layer compositions will be now described in more detail.

In the present application and unless otherwise specified, the refractive indices are determined at 25° C. at a wavelength of 589 nm.

The first lower layer composition having an initial porosity is obtained by dipping the substrate into a sol comprising at least one colloidal mineral oxide with a refractive index higher than or equal to 1.80 and optionally a binder, or by spin coating said sol, preferably by dipping.

For dip coating, the thickness deposited depends on the sol's solids content, on the particle size and on the dewetting rate (Landau-Levich law). Therefore, considering the sol composition, the particle size, the refractive index of the material resulting from the upper layer composition which will diffuse within said lower layer and will fill the porosity thereof, and due to the fact that such filling does not substantially modify the thickness of the lower layer deposited, the thickness required for the colloidal mineral oxide layer can be determined as well as the dewetting rate suitable for obtaining the desired thickness.

After drying of the deposited layer, a porous colloidal mineral oxide layer is obtained, with the expected thickness.

The layer porosity is an important parameter and should be preferably of at least 40% by volume, more preferably of at least 50% in the absence of any binder and preferably of at least 25%, more preferably of at least 30% by volume, in the presence of a binder.

Drying the layer after deposition may be performed at a temperature ranging from 20 to 130° C., preferably from 20° C. to 120° C., for a time period generally shorter than 15 minutes.

Preferably, drying is performed at room temperature (20-25° C.). The preferred duration for the treatment at room temperature does range from about 3 to 5 minutes.

The porosity of the layers may be calculated from refractive indices of the layers measured by ellipsometry.

For a Layer with No Binder

The porosity of the porous colloidal mineral oxide layer is p=Vₚ/(V_{c}+Vₚ) where Vₚ is the pore volume in the layer, and V_{c} is the volume of mineral oxide in the layer.

The porosity p of the layer is here the same as the porosity with no binder.

The porosity value of the layer p can be calculated from the refractive indices:
n (measured by ellipsometry) which is the refractive index of the porous mineral layer,
n_{c} which is the average refractive index of the mineral oxide particles (optionally mixed if a plurality of oxides are used) and of the relation: n²=p+n_{c}²(1−p) where p is the pore volume fraction, on the supposition that the pores are filled with air and that the mineral oxide volume fraction is 1−p.
   For a Layer with a Binder

The layer porosity p is calculated from the following relations:

n²=p+x_{c}n_{c}²+xₗnₗ² (1)

where
n is the refractive index of the mineral oxide porous layer,
p, porosity of the layer=Vₚ/Vₜₒₜₐₗ,
x_{c} is the mineral oxide volume fraction in the layer

x_{c}=V_{c},/Vₜₒₜₐₗ,
xₗ is the binder volume fraction in the layer

xₗ=Vₗ/Vₜₒₜₐₗ
Vₚ, V_{c}, Vₗ, Vₜₒₜₐₗ are respectively the volumes occupied by the pores (air), the mineral oxide, the binder and by the whole layer, n_{c} is the average refractive index of the mineral oxide particles, nₗ is the refractive index of the binder,

p+xₗ+x_{c}=1 (2)

xₗ/x_{c}=(mₗ/m_{c})·(d_{c}/dₗ) (3)

d_{c}=mineral oxide density,

dₗ=binder density,

mₗ=solids content of the binder in the layer,

m_{c}=solids content of the mineral oxide in the layer.

The porosity in the absence of any binder is, by definition, p′=p+xₗ, that is to say does correspond to the porosity the layer would have if the binder volume was occupied by air.

p and p′ values are obtained by measuring n, by ellipsometry, n_{c} and nₗ indices being already known and the mₗ/m_{c} ratio being set experimentally.

The various refractive indices are determined at 25° C. at wavelength 589 nm (n_{D}²⁵).

Preferably, the first lower layer, once its initial porosity has been filled, has a high refractive index of at least 1.70, preferably of at least 1.75 and more preferably ranging from 1.75 to 1.85.

When a second lower layer is deposited and its initial porosity has been filled, this may typically have a physical thickness of from 70 to 90 nm or from 250 to 290 nm.

The particle size of the one or more colloid mineral oxide(s) in the lower layer(s) does range from 5 to 80 nm, preferably from 10 to 30 nm.

Particularly mineral oxide may be composed of a mixture of small sized-particles, i.e. ranging from 10 to 15 nm and of large sized-particles, i.e. ranging from 30 to 80 nm.

The one or more colloid mineral oxide(s) of the first lower layer is or are preferably selected from TiO₂, ZrO₂, SnO₂, Sb₂O₃, Y₂O₃, Ta₂O₅ and combinations thereof.

In a particular embodiment, the dispersed particles have a composite structure based on TiO₂, SnO₂, ZrO₂ and SiO₂. In such a structure, titanium TiO₂ comes preferably as rutile, since the titanium rutile phase is less photo-active than the anatase phase.

Other oxides or chalkogenides selected in the group consisting of ZnO, IrO₂, WO₃, Fe₂O₃, FeTiO₃, BaTi₄O₉, SrTiO₃, ZrTiO₄, MoO₃, CO₃O₄, SnO₂, bismuth-based ternary oxide, RuO₂, Sb₂O₄, BaTi₄O₉, MgO, CaTiO₃, V₂O₅, Mn₂O₃, CeO₂, Nb₂O₅, RuS₂ may also be used as nanoparticles for the high index layer.

Examples of particularly recommended colloids include 1120 Z 9 RS-7 A15 colloid (composite TiO₂ particles with a refractive index of 2.48) or 1120 Z colloid (8RX7-A15) (composite TiO₂ particles with a refractive index of 2.34). Both colloids may be obtained from the CCIC company.

The binder is generally a polymer material that does not affect the optical properties of the lower layer(s) and that enhances the cohesion and adhesion of the mineral oxide particles to the substrate surface.

Preferred binders are polyurethane latexes and (meth)acrylic latexes, very especially polyurethane type latexes.

The binder is preferably a polyurethane latex.

The binder, when present, typically accounts for 0.1 to 10% by weight, more preferably 0.1 to 5% by weight of the dry mineral oxide total weight in the lower layer(s).

Preferably, none of the first and second lower layers contains a binder.

The second lower layer, when present, comprises at least one colloidal mineral oxide with a refractive index lower than 1.65 and has an initial porosity at least equal to, preferably higher than the initial porosity of said first layer.

When the porosity of the second lower layer is higher than that of the first lower layer, it does result therefrom that a greater amount of the upper layer composition as compared to the first lower layer will penetrate into the second lower layer to fill the same.

Since the refractive index of the upper layer is low, filling the different porosities in the two lower layers as such already results in an index difference between these two layers, the second lower layer having a lower index than the first lower layer.

The second lower layer, when present, comprises preferably at least one low index colloidal mineral oxide (n_{D}²⁵≦1.50), preferably colloidal silica, and if appropriate, a lower amount of at least one high index colloidal mineral oxide (n_{D}²⁵>1.54). The high index colloidal mineral oxide is generally selected from those mentioned for making the first lower layer.

Preferred colloidal silicas are silicas prepared by means of the Stöber method. The Stöber method is a simple and well known method which consists in hydrolyzing through ammonia catalysis, then condensing ethyl tetrasilicate (Si(OC₂H₅)₄ or TEOS) in ethanol. The method makes it possible to obtain silica directly in ethanol, an almost monodispersed population of particles, an adjustable particle size and a particle surface (SiO—NH4+).

It is possible, in order to reduce the refractive index of the second lower layer, to use silica hollow particles, such as those described in the patent applications WO2006/095469, JP2001-233611.

However, it is preferred, for mechanical properties regarding reasons, to use traditional silica particles.

Preferably, the weight ratio low index colloidal mineral oxide/high index mineral oxide of the second lower layer varies from 0 to 10%, preferably from 0 to 5%.

More preferably, the second lower layer does not contain high refractive index colloidal mineral oxide.

Preferably, the upper layer composition, with a low refractive index (LI) may be made of any curing composition, preferably any heat-curing composition, providing a low refractive index material, that is to say with a refractive index of from 1.38 to 1.53, preferably of from 1.40 to 1.50, more preferably of from 1.45 to 1.49 and capable of penetrating into the previously deposited lower layer(s) and filling the porosity thereof.

In a preferred embodiment, the (LI) upper layer composition is an hydrolyzate of at least one silane, preferably of at least one epoxyalkoxysilane.

Preferred epoxyalkoxysilanes comprise an epoxy group and three alkoxy groups, these being directly bound to the silicon atom. Especially preferred epoxyalkoxysilanes have the following formula (I):

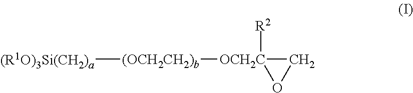

wherein:

R¹ is an alkyl group comprising from 1 to 6 carbon atoms, preferably a methyl or an ethyl group,

R² is a methyl group or an hydrogen atom,

a is an integer ranging from 1 to 6,

b is 0, 1 or 2.

Examples of such epoxysilanes include γ-glycidoxypropyl-triethoxysilane or γ-glycidoxypropyltrimethoxysilane, glycidoxymethyl-trimethoxysilane, glycidoxymethyl triethoxysilane, glycidoxymethyl tripropoxysilane, glycidoxymethyl tributoxysilane, beta-glycidoxyethyl trimethoxysilane, beta-glycidoxyethyl triethoxysilane, beta-glycidoxyethyl tripropoxysilane, beta-glycidoxyethyl tributoxysilane, beta-glycidoxyethyl trimethoxysilane, alpha-glycidoxyethyl triethoxysilane, alpha-glycidoxyethyl tripropoxysilane, alpha-glycidoxyethyl tributoxysilane, gamma-glycidoxypropyl trimethoxysilane, gamma-glycidoxypropyl triethoxysilane, gamma-glycidoxypropyl tripropoxysilane, gamma-glycidoxypropyl tributoxysilane, beta-glycidoxypropyl trimethoxysilane, beta-glycidoxypropyl triethoxysilane, beta-glycidoxypropyl tripropoxysilane, beta-glycidoxypropyl tributoxysilane, alpha-glycidoxypropyl trimethoxysilane, alpha-glycidoxypropyl triethoxysilane, alpha-glycidoxypropyl tripropoxysilane, alpha-glycidoxypropyl tributoxysilane, gamma-glycidoxybutyl trimethoxysilane, delta-glycidoxybutyl triethoxysilane, delta-glycidoxybutyl tripropoxysilane, delta-glycidoxybutyl tributoxysilane, delta-glycidoxybutyl trimethoxysilane, gamma-glycidoxybutyl triethoxysilane, gamma-glycidoxybutyl tripropoxysilane, gamma-propoxybutyl tributoxysilane, delta-glycidoxybutyl trimethoxysilane, delta-glycidoxybutyl triethoxysilane, delta-glycidoxybutyl tripropoxysilane, alpha-glycidoxybutyl trimethoxysilane, alpha-glycidoxybutyl triethoxysilane, alpha-glycidoxybutyl tripropoxysilane and alpha-glycidoxybutyl tributoxysilane.

γ-glycidoxypropyl trimethoxysilane is preferably used.

Other preferred epoxysilanes are epoxydialkoxysilanes such as γ-glycidoxypropylmethyl dimethoxysilane, γ-glycidoxypropylmethyl diethoxysilane, γ-glycidoxypropyl-methyl diisopropenoxysilane, and γ-glycidoxyethoxypropylmethyl dimethoxysilane.

The silane-based hydrolyzate is prepared in a manner that is known per se.

In addition the composition may include a tri- or dialkoxysilane devoid of any epoxy group or a precursor compound of formula Si(W)₄ wherein W groups are hydrolyzable groups, that are the same or different, under the proviso that W groups are not all at the same time a hydrogen atom.

Such hydrolyzable W groups are preferably a group such as OR, Cl, H, R being an alkyl, preferably a C₁-C₆ alkyl such as CH₃, C₂H₅, C₃H₇.

The techniques described in the U.S. Pat. No. 4,211,823 may be used.

The curing composition of the (LI) low index upper layer may also comprise a precursor fluorosilane. This enables to provide a low refractive index to the material matrix of the upper layer and of the second lower layer, when present, and thus to obtain a more efficient anti-reflection coating. However, the precursor fluorosilane is preferably used in small amounts in the curing composition of the upper layer since the lower its refractive index, the more it contributes to the reduction of the lower layer refractive index (or of the first lower layer refractive index when two lower layers are used), once this has been filled, whereas the lower layer refractive index needs to be high for the AR coating to be efficient. Indeed, the more numerous precursor fluorosilanes are in the upper layer composition, the higher the refractive index of the lower layer of the stack (or the first lower layer of the stack) should be, prior to filling the porosity thereof. Preferably, the precursor fluorosilane is comprised in an amount by weight of at most 20% and more preferably of at most 10% of the total weight of the silanes contained in said upper layer composition.

As previously indicated, the precursor fluorosilane comprises at least two hydrolyzable groups per molecule.

The precursor fluorosilane hydrolyzable groups (noted X in the following description) are directly bound to the silicon atom.

More precisely, preferred precursor fluorosilanes include fluorosilanes of formulas:

Rf—SiR′ₐX₃₋ₐ 1.

wherein Rf is an organic C₄-C₂₀ fluorinated group, R′ is a monovalent C₁-C₆ hydrocarbon group, X is a hydrolyzable group and a is an integer from 0 to 2; and

CF₃CH₂CH₂—SiR′ₐX₃₋ₐ 2.

wherein R′, X and a are such as previously defined.

Preferably, Rf is a polyfluoroalkyl group of formula CₙF₂ₙ₊₁—Y_{y} or CF₃CF₂CF₂ O(CF(CF₃)CF₂O)ⱼ CF(CF₃)Y_{y}, Y is (CH₂)ₘ, CH₂O, NR″, CO₂, CONR″, S, SO₃ and SO₂NR″; R″ is H or a C₁-C₈ alkyl group, n is an integer from 2 to 20, y is 1 or 2, j is an integer from 1 to 50, preferably from 1 to 20, and m is an integer from 1 to 3.

Precursor fluorosilanes are preferably polyfluoroethers and more preferably poly(perfluoroethers). These fluorosilanes are well known and are described amongst others in the patents U.S. Pat. No. 5,081,192; U.S. Pat. No. 5,763,061, U.S. Pat. No. 6,183,872; U.S. Pat. No. 5,739,639; U.S. Pat. No. 5,922,787; U.S. Pat. No. 6,337,235; U.S. Pat. No. 6,277,485 and EP-933 377.

Another preferred class of fluorosilanes are those containing fluoropolyether groups described in U.S. Pat. No. 6,277,485.

These fluorosilanes have the following general formula:

RfR¹—SiY₃₋ₓR²X]_{y}

wherein Rf is a monovalent or divalent perfluoro polyether group; R¹ is a divalent alkylene group, arylene group, or combinations thereof, optionally containing one or more heteroatoms or functional groups and optionally substituted with halide atoms, and preferably containing 2 to 16 carbon atoms; R² is a lower alkyl group (i.e., a C₁-C₄ alkyl group); Y is a halide atom, a lower alkoxy group (i.e., a C₁-C₄ alkoxy group, preferably, a methoxy or ethoxy group), or a lower acyloxy group (i.e., —OC(O)R³ wherein R³ is a C₁-C₄ alkyl group); x is 0 or 1; and y is 1 (Rf is monovalent) or 2 (Rf is divalent).

Suitable compounds typically have a number average molecular weight of at least 1000.

Preferably, Y is a lower alkoxy group and Rf is a perfluoro polyether group.

Other recommended fluorosilanes are those having following formula:

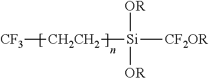

wherein n=5, 7, 9 or 11 and R is an alkyl radical, preferably a C₁-C₆ alkyl such as —CH₃, —C₂H₅ and —C₃H₇;

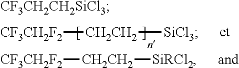

wherein n′=7 or 9 and R is such as defined hereabove.

Also recommended fluorosilanes are organic group-containing fluoropolymers described in the U.S. Pat. No. 6,183,872.

Organic group-containing fluoropolymers carrying Si groups are represented by the following general formula and have a molecular weight ranging from 5·10² to 1·10⁵:

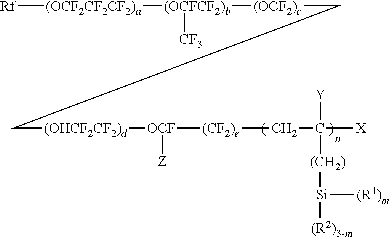

wherein Rf represents a perfluoroalkyl group, Z represents a fluorine atom or a trifluoromethyl group, a, b, c, d and e each independently represent 0 or an integer equal to or higher than 1, provided that a+b+c+d+e is not less than 1 and the order of the repeating units parenthesized by subscripts a, b, c, d and e is not limited to that shown; Y represents a hydrogen atom or an alkyl group containing 1 to 4 carbon atoms; X represents a hydrogen, bromine or iodine atom; R¹ represents a hydroxyl group or a hydrolyzable group; R² represents a hydrogen atom or a monovalent hydrocarbon group; l is 0, 1 or 2; m is 1, 2 or 3; and n″ is an integer equal to or higher than 1, preferably at least equal to 2.

A recommended fluorosilane is marketed under the trade name Optool DSX®.

Tridecafluoro-1,1,2,2-tetrahydroctyl-1-triethoxysilane (CF₃(CF₂)₅CH₂CH₂Si(OC₂H₅)₃) will be preferably used.

When the composition comprises a precursor fluorosilane, the resulting anti-reflection coating may have anti-fouling properties, thus making unnecessary to subsequently deposit a hydrophobic and/or oleophobic layer.

The upper layer composition may include colloids which refractive index should remain low, typically lower than 1.52, more preferably lower than 1.50. Typically the colloid used is colloidal silica.

The colloidal silica solids content may vary generally from 0 to 50% by weight of the theoretical solids content weight of the upper layer composition.

The theoretical solids content is calculated as described in the patent EP 614 957.

If colloidal silica particle size is low, these particles may penetrate within the porous lower layer(s).

If the particle size is higher than the pore size, one may think that the colloids will remain on the surface of the lower layer(s) and that only the non colloidal curable material will penetrate into the pore volume.

The upper layer composition generally includes a curing catalyst.

Suitable examples of curing catalysts for the upper layer composition include amongst others aluminium compounds and especially such aluminium compounds chosen from:
aluminium chelates, and
compounds of formulas (II) or (III) as detailed hereunder:

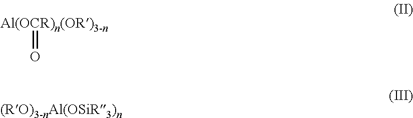

wherein:

R and R′ are linear or branched chain-alkyl groups with from 1 to 10 carbon atoms,

R″ is a linear or branched chain-alkyl group with from 1 to 10 carbon atoms, a phenyl group or a group

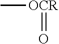

wherein R is such as defined hereabove, and n is an integer ranging from 1 to 3.

As is known, an aluminium chelate is a compound formed by reacting an alcoholate or an aluminium acylate with sequestering agents free of nitrogen and sulfur and comprising oxygen as the coordinating atom.

The aluminium chelate is preferably selected from compounds of formula (IV):

AlXᵥY₃₋ᵥ (IV)

wherein:
X is an OL group where L is an alkyl group comprising from 1 to 10 carbon atoms,
Y is at least one ligand derived from a compound of formula (1) or (2):

M¹COCH₂COM² (1)

M³COCH₂COOM⁴ (2)

wherein
M¹, M², M³ and M⁴ are alkyl groups with from 1 to 10 carbon atoms, and v is 0, 1 or 2.

Examples of compounds of formula (IV) include aluminium acetylacetonate, aluminium ethylacetoacetate bisacetylacetonate, aluminium bisethylacetoacetate acetylacetonate, aluminium di-n-butoxide monoethylacetoacetate and aluminium di-n-propoxide mono-methylacetoacetate.

Amongst compounds of formula (III) or (IV), those are preferably chosen wherein R′ is an isopropyl or an ethyl group, and R and R″ are methyl groups.

Especially advantageous is the use of aluminium acetyl-acetonate as a curing catalyst for the upper layer composition, in an amount ranging from 0.1 to 5% by weight of the composition total weight.

Other curing catalysts may be used, such as amine salts, for example catalysts marketed by the Air Products company under the trade names POLYCAT SA-1/10®, DABCO 8154® and DABCODA-20®, tin salts such as the product marketed by the Acima company under the trade name METATIN 713®.

The upper layer composition may also comprise one or more surfactants, especially fluorinated or fluorosiliconated surfactants, generally in an amount ranging from 0.001 to 1% by weight, preferably from 0.01 to 1% by weight, relative to the composition total weight. Preferred surfactants include FLUORAD® FC430 marketed by the 3M company, EFKA 3034® marketed by the EFKA company, BYK-306® marketed by the BYK company and Baysilone OL31® marketed by the BORCHERS company.

The lower layer composition(s) may also comprise surfactants such as those described hereabove, but preferably they will not contain any.

The upper layer composition, like the lower layer composition(s) of the invention, generally includes at least one organic solvent. Suitable organic solvents for use in the present invention include alcohols, esters, ketones, tetrahydropyran, and combinations thereof.

Alcohols are preferably selected from (C₁-C₆) lower alcohols, such as methanol, ethanol and isopropanol.

Esters are preferably selected from acetates, and ethyl acetate should be especially mentioned.

Amongst ketones, methyl ethyl ketone will be preferably used.

Suitable solvents include for example:
methanol (CH₃OH, Carlo Erba),
1-propanol (CH₃CH₂CH₂OH, VWR International),
1-methoxy-2-propanol (CH₃CH(OH)CH₂OCH₃, Sigma Aldrich),
4-hydroxy-4-methyl-2-pentanone (CH₃)₂C(OH)CH₂COCH₃, VWR International),
2-methyl-2-butanol ((CH₃)₂C(OH)CH₂CH₃ Sigma Aldrich),
butoxyethanol (CH₃(CH₂)₃OCH₂CH₂OH, Sigma Aldrich),
water/organic solvent mixture,
or any combination of these solvents containing at least one alcohol.

(HI) and (LI) compositions may also include other additives such as UV absorbers or pigments.

In the method for making an article of the invention such as previously defined, the lower and higher layer compositions according to the invention may be deposited by any suitable technique, by means of a liquid process that is known per se i.e. deposition by dip coating or deposition by spin coating in particular.

Deposition by dip coating is preferred, the method according to the invention being particularly well adapted to such deposition technique, since it enables to reduce, or even to avoid the occurrence of optical defects.

The method of the invention typically comprises, between the deposition of each layer, a drying and/or pre-curing step of the previous layer prior to depositing the subsequent layer.

As regards the upper layer composition, this should have diffused, at least partially or in whole, within the lower layer(s) prior to performing the curing thereof.

Typically the diffusion and filling time is short and these actions may proceed at least partially during the dipping or spin coating deposition operation.

Pre-curing is for example a drying operation conducted at room temperature, an infrared treatment, optionally followed with a cooling step using an air flow at room temperature, or a convection drying in an oven.

Pre-curing is preferably a drying operation conducted at room temperature.

To ensure a proper reproducibility of the anti-reflection coatings and the absence of optical defects, it is preferred to carry out the deposition under reproducible conditions.

It is especially recommended to work under generally constant, moisture-controlled conditions.

It is possible to work under high moisture content conditions (higher than 55%), under conditions corresponding to the ambient moisture or under low moisture content conditions (typically of from 5 to 40%).

Typically, low moisture content conditions will be preferred (lower than or equal to 10%).

Controlling the moisture content is well known in the art and is described for example in the U.S. Pat. No. 5,856,018, US 2005/0,233,113, US 2005/0,266,208.

Anti-reflection coatings of the invention may be deposited onto any suitable substrate whether in organic or in mineral glass, for example such as ophthalmic lenses in organic glass, where these substrates may be bare or optionally coated with abrasion-resistant or impact-resistant coatings or any other traditionally used coatings.

Suitable organic glass substrates for use in the optical articles of the invention include polycarbonate substrates (PC) and those obtained by polymerizing alkyl methacrylates, especially C₁-C₄ alkyl methacrylates, such as methyl(meth)acrylate and ethyl(meth)acrylate, polyethoxylated aromatic (meth)acrylates such as polyethoxylated bisphenolate dimethacrylates, allyl derivatives such as linear or branched, aliphatic or aromatic polyol allyl carbonates, thio-(meth)acrylic substrates, polythiourethane substrates and polyepisulfide substrates.

Recommended substrates include substrates obtained by polymerizing polyol allyl carbonates including, for example, ethyleneglycol bis allyl carbonate, diethylene glycol bis 2-methyl carbonate, diethyleneglycol bis(allyl carbonate), ethyleneglycol bis(2-chloro allyl carbonate), triethyleneglycol bis(allyl carbonate), 1,3-propanediol bis(allyl carbonate), propylene glycol bis(2-ethyl allyl carbonate), 1,3-butylenediol bis(allyl carbonate), 1,4-butenediol bis(2-bromo allyl carbonate), dipropyleneglycol bis(allyl carbonate), trimethyleneglycol bis(2-ethyl allyl carbonate), pentamethyleneglycol bis(allyl carbonate), isopropylene bis phenol-A bis(allyl carbonate).

Particularly recommended substrates are those substrates obtained by polymerizing diethyleneglycol bis allyl carbonate, sold under the trade name CR 39® by the PPG INDUSTRIE company (ORMA® lens from ESSILOR).

Other recommended substrates also include those substrates obtained by polymerizing thio(meth)acrylic monomers, such as those described in the French patent application FR-A-2 734 827.

Of course, the substrates may be obtained by polymerizing the hereabove mentioned monomers mixtures.

Preferably the substrate has a refractive index ranging from 1.50 to 1.80, preferably from 1.60 to 1.75.

According to another embodiment of the invention, the anti-reflection coating is deposited onto a thin polymer film (typically 50-200 microns, preferably 75-125 microns).

This coated film may thereafter be bond to the surface of a substrate such as previously described.

Suitable for use as an impact-resistant primer layer are all the impact-resistant primer layers traditionally used for articles made of a transparent polymer material, such as ophthalmic lenses.

Preferred primer compositions include compositions based on thermoplastic polyurethanes such as those described in the Japanese patents 63-141001 and 63-87223, poly(meth)acrylic primer compositions, such as those described in the U.S. Pat. No. 5,015,523, compositions based on thermosetting polyurethanes, such as those described in the patent EP-0 404 111 and compositions based on poly(meth)acrylic latexes and polyurethane latexes, such as those described in the patents U.S. Pat. No. 5,316,791 and EP-0680492.

Preferred primer compositions are compositions based on polyurethane and compositions based on latexes, especially polyurethane latexes.

Poly(meth)acrylic latexes are latexes from copolymers essentially composed of a (meth)acrylate, such as for example ethyl- or butyl-(meth)acrylate or methoxy- or ethoxyethyl (meth)acrylate, with a typically minor amount of at least one other comonomer, such as for example styrene.

Preferred poly(meth)acrylic latexes are latexes based on acrylate-styrene copolymers.

Such acrylate-styrene copolymer latexes are commercially available from the ZENECA RESINS company under the trade name NEOCRYL®.

Polyurethane latexes are also known and commercially available.

Polyurethane latexes comprising polyester units may also be mentioned as suitable examples. Such latexes are also marketed by the ZENECA RESINS company under the trade name NEOREZ® and by the BAXENDEN CHEMICAL company under the trade name WITCOBOND®.

Combinations of these latexes may also be employed in the primer compositions, especially combinations of polyurethane latexes and poly(meth)acrylic latexes.

These primer compositions may be deposited onto the optical article faces by dipping or spin-coating, thereafter be dried at a temperature of at least 70° C. and up to 100° C., preferably of about 90° C., for a time period ranging from 2 minutes to 2 hours, generally of about 15 minutes, to form primer layers which thicknesses, after curing, range from 0.2 to 2.5 μm, preferably from 0.5 to 1.5 μm.

Hard anti-abrasion coatings of the optical articles of the invention, and especially of ophthalmic lenses, may be any abrasion-resistant coatings known in the ophthalmic optics field.

Recommended hard anti-abrasion coatings for use in the present invention include the coatings obtained from silane hydrolyzate-based compositions, especially epoxysilane type hydrolyzate, for example those described in the patents EP 0614 957 and U.S. Pat. No. 4,211,823, or compositions based on (meth)acrylic derivatives.

A preferred anti-abrasion hard coating composition comprises a hydrolyzate based on epoxysilane and dialkyl dialkoxysilane, colloidal silica and aluminium acetylacetonate in a catalytic amount, the remaining being essentially composed of solvents traditionally used for formulating such compositions.

The hydrolyzate to be preferably used is a hydrolyzate based on γ-glycidoxypropyl trimethoxysilane (GLYMO) and dimethyl diethoxysilane (DMDES).

In a particular embodiment of the invention, the substrate onto which the anti-reflection coating of the invention is deposited already includes an initial porous layer.

The one or more lower layer(s) and the upper layer may be successively deposited onto this initial porous layer, with the upper layer composition filling the porosity of all these layers, including that of the initial layer.

The colloidal mineral metal oxide sol forming said first lower layer is directly deposited onto the initial layer and the material of the upper layer composition does fill the porosity and said layer, once the porosity thereof has been filled, forms a layer with an intermediate refractive index, creating with the one or more lower layer(s) and the upper layer a trilayered anti-reflection coating with an intermediate index (II)/high index (HI)/low index (LI) structure.

Therefore, the refractive index and the porosity of the initial layer are determined so as to form a layer with an intermediate refractive index, once the porosity thereof has been filled, and correspond to the first layer of a trilayered anti-reflection stack.

Preferably, the initial layer is obtained by depositing a sol comprising a mixture of low refractive index oxides (lower than 1.52, preferably lower than 1.50) and of high refractive index oxides (higher than or equal to 1.80), so as to obtain, once the initial layer initial porosity has been filled, a refractive index in the range from 1.53 to 1.65

As previously indicated, anti-reflection coatings for optical articles of the invention may optionally be coated with coatings enabling to change their surface properties, such as hydrophobic anti-fouling coatings. There are generally materials of the fluorosilane type, with a thickness of a few nanometers, preferably ranging from 1 to 10 nm, more preferably from 1 to 5 nm.

The fluorosilanes used may be the same as the precursor silanes (II) of the composition forming the low index upper layer, but they are used in high concentrations or neat in the anti-fouling layer.

When the upper layer composition itself comprises a fluorosilane, it is generally unnecessary to deposit an additional anti-fouling layer since the upper layer plays this role.

But even so, an additional layer of very performing fluorinated silanes, such as Optool DSX™, may be deposited to obtain optimal anti-fouling performances.

The present invention may be used for making anti-reflection coatings in the most various technical fields using anti-reflection coatings such as flat-panel displays, computer screens, optics articles such as ophthalmic lenses, especially for eyeglasses.

The following description does refer to the appended figures which show, respectively:

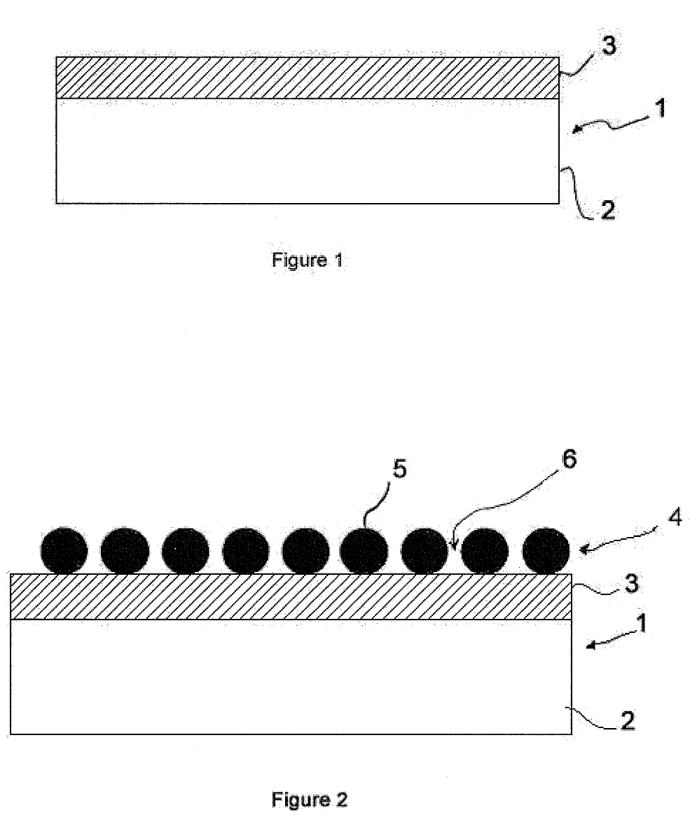

in FIG. 1 a schematic illustration of the coated article onto which the anti-reflection coating according to the invention is to be deposited;

in FIG. 2 a schematic illustration of an article coated with a first lower layer according to the invention;

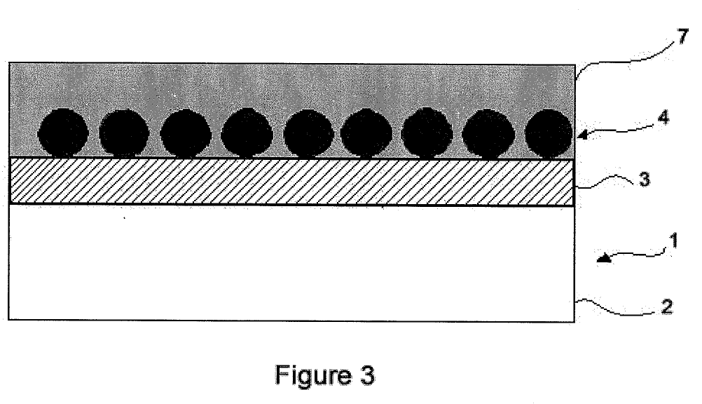

in FIG. 3 a schematic illustration of an article coated with a lower layer and an upper layer forming a bilayered anti-reflection coating, according to a first embodiment of the invention;

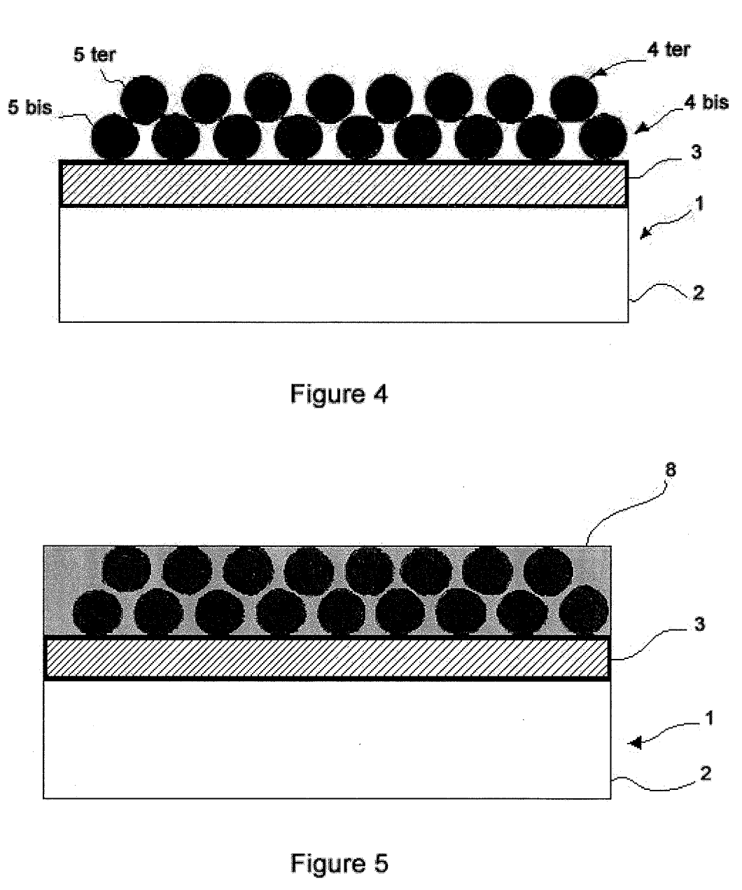

in FIG. 4 a schematic illustration of an article coated with two lower layers according to the invention, prior to applying the upper layer; and

in FIG. 5 a schematic illustration of an article coated with an anti-reflection coating obtained according to a second embodiment of the invention.

FIGS. 1 to 3 show the various steps for making an anti-reflection coating according to a first embodiment of the invention.

The deposition is performed onto an article 1 illustrated in FIG. 1 comprising a substrate 2 which may be in organic or mineral glass and an abrasion-resistant coating 3.

Thereafter, a thin layer 4 of a sol from a colloidal mineral oxide with a refractive index higher than 1.80 is deposited.

After deposition and evaporation of the solvents, the layer 4 is obtained, with a porosity 6 between particles 5. The size and the density of particles enable the expected porosity to be adjusted. In the layer 4 of FIG. 2, particles are illustrated as being not joined but they may be joined if they are bigger or more numerous.

In a second step, an upper layer 7 shown in FIG. 3 is to be deposited, which will fill the porosity 6 of the lower layer 4 and the residual thickness of layer 7 forms the low index layer of a bilayered anti-reflection stack.

FIGS. 4 and 5 illustrate a second embodiment of the invention wherein two lower layers 4bis and 4ter are successively deposited.

Although in FIG. 4, particles of the same size are represented, they may have different sizes so that the porosity of lower layers 4bis and 4ter differ and layer 4ter has a higher porosity as compared to layer 4bis.

Colloid particles 5bis may have and have generally a higher refractive index than particles 5ter do.

When layers 4ter and 4bis have been dried, a solution from higher layer 8 is deposited, which amount is adjusted so as to penetrate into the porosity of both layers 4ter and 4bis.

In the two embodiments of the invention illustrated hereabove, the amount may be determined experimentally by depositing a given thickness of the higher layer solution and by measuring the residual thickness after filling of the porosity.

Thereafter, the amount of the higher layer solution to be suitably deposited to form the known required thickness to obtain the AR properties should be adjusted.

In the following example, the product marketed under the trade name Optolake 1120Z® (9 RS7-A15) by the Catalyst & Chemical company was used as a sol of colloidal mineral particles coated with the lower layer composition.

In general, the anti-reflection coatings of the articles of the invention have reflection factors Rₘ (average reflection between 400 and 700 nm) that can be compared to those of the anti-reflection coatings from the prior art. Indeed, the anti-reflection coatings of the invention generally have a Rₘ value lower than 1.4% and a Rᵥ value lower than 1.6%, and may reach Rv values that are lower than 1%.

Definitions of reflection factors (C_{R}) at a given wavelength and Rₘ (average reflection between 400 and 700 nm) are well known from the person skilled in the art and are mentioned in the standard document ISO/WD 8980-4.

The “mean luminous reflection factor”, noted Rᵥ, is such as defined in the standard ISO 13666:1998, and measured in accordance with the standard ISO 8980-4, in other words it is the spectral reflectivity weighted average within the whole range of the visible spectrum of from 380 to 780 nm.

As already stated hereabove, the optical articles of the invention are provided with outstanding optical properties and are free of any visually perceptible cosmetic defect.

An example of one embodiment will now be described in more detail to illustrate the present invention without being limitative thereof.

To appreciate the coated glass properties obtained in the following examples, the following parameters may be measured:
the reflection factor (C_{R}) at a given wavelength and Rₘ (average reflection between 400 and 700 nm) in accordance with the standard ISO/WD 8980-4;
the “mean luminous reflection factor,” noted Rᵥ, is such as defined in the standard ISO 13666:1998, and measured in accordance with the standard ISO 8980-4, in other words it is the spectral reflectivity weighted average within the whole range of the visible spectrum of from 380 to 780 nm.

The ratios, percentages and amounts mentioned in the example are ratios, percentages and amounts expressed by weight unless otherwise specified.

In the following examples, the supports are ophthalmic lenses based on diethyleneglycol diallyl carbonate coated with an impact-resistant primer based on latex W234™ and with an abrasion-resistant coating.

Impact-Resistant Primer:

The impact-resistant primer is obtained from a latex W234™, diluted so that a thickness of about 1 μm will be deposited onto the substrate.

Abrasion-Resistant Coating:

The abrasion-resistant coating composition is prepared according to the procedure of Example 3 in the patent EP 614 957 to the applicant, by adding dropwise 42.9 parts of hydrochloric acid 0.1 N to a solution comprising 135.7 parts of y-glycidoxypropyl triethoxysilane (GLYMO) and 49 parts of dimethyl diethoxysilane (DMDES). The hydrolyzed solution is stirred for 24 hours at room temperature and thereafter 8.8 parts of aluminium acetylacetonate, 26.5 parts of ethylcellosolve, 400 parts of colloidal silica MAST (colloid silica particles of diameter 10-13 nm, 30% in methanol) and 157 parts of methanol are added thereto.

A small amount of a surfactant is then incorporated. The theoretical solids content of the composition comprises about 10% of solids derived from hydrolyzed DMDES.

### EXAMPLE 1

In this example, a bilayered anti-reflection coating is prepared, composed of a lower layer with optical thickness λ/2 and an upper layer with optical thickness λ/4 (thickness of the upper layer after filling of the porosity of the lower layer).

Lower Layer Solution:

This solution is composed of an alcoholic solution (ethanol solution) of colloid 1120 Z 9 RS-7 A15 (composite TiO₂ particles with a refractive index of 2.48) from the CCIC company, with 10% by weight of solids content.

Upper Layer Solution:

It is the same composition as that of the abrasion-resistant coating, the dilution of which has been adapted so as to reach 2.5% of solids content.

The surfactant EFKA 3034 is used in the higher layer solution in an amount of 0.2% by weight.

Implementation:

A lower layer is deposited by dipping into a bath containing the lower layer described hereabove, the temperature of the bath being maintained at 20° C. (lifting rate 2 mm/s).

Thereafter the layer is dried in the air for 5 minutes at a temperature ranging from 25 to 30° C.

The physical thickness of the resulting layer once dry is of 140 nm.

In a second stage, an upper layer composition with a theoretical physical thickness of 140 nm (Landau-Levich law) is deposited onto this lower layer by dipping (lifting rate of 1.5 mm/s) into a bath containing the upper layer solution, the temperature of the bath being maintained at 7° C.

After removal from the bath, the article comprising the stack composed of the two layers is submitted to a pre-polymerization at a temperature of 75° C., followed with a 3 h-polymerization at 100° C.

The physical thickness of the upper layer in the final article is of 80 nm. (thickness of the lower layer: 140 nm).

The anti-reflection coating properties measured in a SMR apparatus are as follows:

Rₘ: from 0.9 to 1.1%

Rᵥ: from 1.3 to 1.5%

These values are expressed per face.

The resulting lenses are free of any visually perceptible defect.

### EXAMPLE 2

Example 1 is repeated, except that the thickness values have been modified.

The resulting final article has an antireflection coating lower layer thickness of 72 nm (with a refractive index of 1.80) and an upper layer thickness of 105 nm (with a refractive index of 1.48).

Rᵥ=0.50% per face.

1. A method for manufacturing an optical article with anti-reflection properties, comprising the steps of:
a) forming on at least one main surface of a support, by applying a sol comprising at least one colloidal mineral oxide with a refractive index higher than or equal to 1.80 and optionally a binder, a first lower layer comprising at least one colloidal mineral oxide with a refractive index higher than or equal to 1.80 and optionally a binder, having an initial porosity;
b) optionally, forming a second lower layer having an initial porosity at least equal to, preferably higher than the initial porosity of said first layer, on the first lower layer by applying a sol comprising at least one colloidal mineral oxide with a refractive index lower than 1.65 and optionally a binder;
c) applying onto the one or more lower layer(s) an upper layer composition of an optically transparent polymer material with a refractive index lower than or equal to 1.50;
d) filling the porosity of the one or more lower layer(s) through penetration into the one or more lower layer(s) of at least part of the material of the upper layer composition formed at step (c) and, optionally, part of the binder, and forming a cured upper layer which thickness is determined so that the upper layer and the one or more lower layer(s), once the initial porosity thereof has been filled, form a bilayered anti-reflection coating, providing the optical article with a reflection factor Rᵥ≦2.5%.

2. A method according to claim 1, wherein the bilayered anti-reflection coating forms a stack having an optical thickness of λ/2-λ/4 or λ2-3λ/4 for a wavelength λ ranging from 500 to 600 nm.

3. A method according to claim 1 or 2, wherein said first lower layer, once its initial porosity has been filled, has a physical thickness ranging from 100 to 160 nm.

4. A method according to any one of claims 1 to 3, which does not comprise any step of forming a second lower layer, wherein the bilayered anti-reflection coating is comprising said first lower layer once its initial porosity has been filled and of the upper layer.

5. A method according to claim 4, wherein the upper layer has a physical thickness ranging from 70 to 90 nm.

6. A method according to claim 4, wherein the upper layer has a physical thickness ranging from 250 to 290 nm.

7. A method according to any one of claims 1 to 3, which comprises the implementation of step b) and wherein the whole material of the upper layer composition has penetrated into the one or more lower layer(s) and the bilayered anti-reflection coating is formed with said first and second layers once their pores have been filled.

8. A method according to claim 7, wherein the second lower layer, once its initial porosity has been filled, has a physical thickness ranging from 70 to 90 nm.

9. A method according to claim 7, wherein the second lower layer, once its initial porosity has been filled, has a physical thickness ranging from 250 to 290 nm.

10. A method according to any one of the preceding claims, wherein the first lower layer, once its initial porosity has been filled, has a high refractive index of at least 1.70, preferably of at least 1.75.

11. A method according to any one of claims 1 to 10, wherein the initial porosity of the first or the second layer, in the absence of any binder, is of at least 40% by volume.

12. A method according to claim 10, wherein the initial porosity of the first or the second layer is of at least 50% by volume in the absence of any binder.

13. A method according to any one of claims 1 to 12, wherein the particle size of the one or more colloid mineral oxide(s) does range from 5 to 80 nm, preferably from 10 to 30 nm.

14. A method according to any one of claims 1 to 13, wherein the sol(s) of at least one colloidal mineral oxide further comprise(s) a binder accounting for 0.1 to 10% by weight, of the dry mineral oxide total weight in the lower layer(s).

15. A method according to any one of claims 1 to 13, wherein none of the first and second lower layers contains a binder.

16. A method according to any one of claims 1 to 14, wherein the binder is a polyurethane latex.

17. A method according to any one of the preceding claims, wherein at least one colloidal mineral oxide of the first lower layer is selected from TiO₂, ZrO₂, SnO₂, Sb₂O₃, Y₂O₃, Ta₂O₅ and combinations thereof.

18. A method according to any one of claims 1 to 3 and 7 to 17, which comprises the step of forming on the first lower layer, by applying a sol comprising at least one colloidal mineral oxide with a refractive index lower than 1.65 and optionally a binder, a second lower layer having an initial porosity at least equal to the initial porosity of said first layer, said second lower layer comprising at least one low refractive index colloidal mineral oxide (n_{D}²⁵≦1.50).

19. A method according to any one of the preceding claims, wherein the upper layer composition comprises at least one epoxyalkoxysilane hydrolyzate.

20. A method according to any one of the preceding claims, wherein the one or more lower layer(s) and the upper layer are deposited by dip coating and/or spin coating, preferably by dip coating.

21. A method according to any one of preceding claims, which comprises an additional step for depositing an anti-fouling layer.

22. A method according to any one of the preceding claims, wherein the support is a substrate of organic or mineral glass.

23. A method according to claim 22, wherein the organic glass substrate is selected from polymers and copolymers of diethyleneglycol bis(allylcarbonate), homo and copolycarbonates, poly(meth)acrylates, polythio(meth)acrylates, polyurethanes, polythiourethanes, polyepoxides, polyepisulfides and combinations thereof.

24. A method according to claim 22 or 23, wherein the substrate has a refractive index ranging from 1.50 to 1.80, preferably from 1.60 to 1.75.

25. A method according to any one of the preceding claims, wherein the support is coated on at least one of the main surfaces thereof with an abrasion-resistant coating prior to depositing the lower layer(s).

26. A method according to any one of the preceding claims, wherein the support is coated with an initial layer having an initial porosity and an initial thickness, onto which the colloidal mineral metal oxide sol forming said first lower layer is directly deposited, and the material of the upper layer composition fills the porosity of the initial layer whereby said layer forms, once the porosity thereof has been filled, a layer with an intermediate refractive index, forming with the one or more lower layer(s) and the upper layer a trilayered MI/HI/LI anti-reflection coating.

27. An optical article, which comprises on at least one of the main surfaces thereof an anti-reflection coating obtained through the method according to any one of the preceding claims.

28. An optical article according to claim 27, wherein the article is an ophthalmic lens, especially for eyeglasses.
